(19) United States
(12) Patent Application Publication
(10) Pub. No.: US 2009/0320682 A1
(43) Pub. Date: Dec. 31, 2009

(54) REMOVAL OF CARBON DIOXIDE FROM COMBUSTION EXHAUST GASES

(75) Inventors: Rupert Wagner, Worms (DE); Ute Lichtfers, Karlsruhe (DE); Volker Schuda, Landau (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patents, Trademarks and Licenses, Ludwigshafen (DE)

(21) Appl. No.: 12/439,077

(22) PCT Filed: Aug. 27, 2007
(86) PCT No.: PCT/EP07/58866

§ 371 Date: Feb. 26, 2009

(30) Foreign Application Priority Data
Aug. 28, 2006 (EP) 06119660.6

(51) Int. Cl. B01D 53/14; C09K 3/00; B01D 19/00

(52) U.S. Cl. 95/172; 252/190; 95/236; 95/183; 95/156

(57) ABSTRACT

The invention relates to an absorbent, comprising an aqueous solution (A) of at least one amino acid salt of the formula (I), wherein R¹ and R² independently from each other represent alkyl or hydroxyalkyl, R is hydrogen, alkyl or hydroxyalkyl, or a group R together with R¹ is alkylene, M is an alkali metal, and n an integer from 1 to 6, and (B) of at least one primary alkanolamine, which is substantially free of inorganic alkaline salts. The absorbent is used in a method for removing carbon dioxide from a gas flow, particularly combustion exhaust gases. Preferred amino acid salts (A) are N,N-dimethylamino acetic acid potassium salt, N,N-diethylamino acetic acid potassium salt and N-ethyl-N-dimethylamino acetic acid-potassium salt. Preferred alkanolamines (B) are 2-aminoethanol, 3-aminopropanol, 4-aminobutanol, 2-aminobutanol, 5-aminopentanol, 2-aminopentanol and 2-(2-aminoethoxy)ethanol.

The present invention relates to an absorption medium and a process for removing carbon dioxide from a gas stream, in particular from combustion exhaust gases of flue gases.

The removal of carbon dioxide from combustion exhaust gases is desirable for various reasons, in particular, however, for reducing the emission of carbon dioxide, which is considered to be the main cause for what is termed the greenhouse effect.

On an industrial scale, for removing acid gases, such as carbon dioxide, from gas streams, use is frequently made of aqueous solutions of organic bases, for example alkanolamines, as absorption media. On dissolution of acid gases, ionic products form in this case from the base and the acid gas components. The absorption medium can be regenerated by heating, expansion to a lower pressure, or by stripping, in which case the ionic products react back to form acid gases and/or the acid gases are stripped off by steam. After the regeneration process, the absorption medium can be reused.

Combustion exhaust gases have a very low carbon dioxide partial pressure, since they generally occur at a pressure close to atmospheric pressure and typically comprise only 3 to 13% by volume carbon dioxide. To achieve effective removal of carbon dioxide, the absorption medium must have a high CO₂ loading capacity at low partial pressures. Secondly, the carbon dioxide absorption must not proceed exothermally too greatly: since the loading capacity of the absorption medium decreases with increasing temperature, the temperature rise caused by a high absorption reaction enthalpy is disadvantageous in the absorber. A high absorption reaction enthalpy causes, moreover, an increased energy consumption in regeneration of the absorption medium. For understandable reasons, the energy requirement for regeneration of the absorption medium (expressed, for example, as kg of steam per kg of CO₂ removed) must be as low as possible.

Since in the scrubbing of combustion exhaust gases, typically large gas volumes are treated at low pressures, the absorption medium, in addition, must have a low vapor pressure in order to keep the absorption medium losses low. The absorption medium in addition, must not exhibit any unwanted interactions with other typical components of combustion exhaust gases such as nitrogen oxides or oxygen.

Frequently, use is made of aqueous solutions of monoethanolamine (2-aminoethanol) for scrubbing combustion exhaust gases. Monoethanolamine is cheap and has a high loading capacity for carbon dioxide. However, the absorption medium losses are high, since monoethanolamine has a comparatively high vapor pressure and in the presence of oxygen at elevated temperatures has a tendency to decomposition, such that the makeup requirement is 1.6 to 2.5 kg of monoethanolamine per ton of carbon dioxide removed. The energy requirement for regeneration is high.

An absorption medium is known under the name Alkazid M which is based on N-methylalanine potassium salt (potassium a-methylaminopropionate). It can be highly loaded like monoethanolamine. The amino acid salt, owing to its ionic structure, has a negligible vapor pressure. It is disadvantageous that the energy requirement for regeneration is similarly high as for monoethanolamine.

Although secondary and tertiary amines such as diethanolamine, diisopropanolamine or methyidiethanolamine cannot be loaded so highly at low CO₂ partial pressures and therefore if appropriate higher circulation rates are required, they can be regenerated with low energy expenditure (kg of steam per kg of carbon dioxide removed). Their insufficient stability in the presence of oxygen is disadvantageous.

EP-A 671 200 describes the removal of CO₂ from combustion gases at atmospheric pressure using an aqueous solution of an amino acid metal salt and piperazine. The amino acid metal salts described are potassium dimethylaminoacetate and potassium α-methylaminopropionate.

Combustion gases usually comprise traces of nitrogen oxides or nitrous gases. These, together with secondary amines such as piperazine, can readily form stable nitrosamines. Nitrosamines is the collective name for N-nitroso compounds of secondary amines. They belong to the most carcinogenic (cancer causing) substances. The cancer-causing action is based on reactive metabolites of nitrosamines in the metabolism which react with the genetic substance DNA, as a result damage it and can cause tumors. Therefore, attempts are made to prevent the introduction of nitrosamines into the environment, where this is technically preventable.

The object of the invention is to specify an absorption medium and a process for removing carbon dioxide from gas streams, in particular combustion exhaust gases, which is distinguished by (i) a reduced potential for forming harmful nitrosamines, (ii) high CO₂ absorption rate, (iii) high CO₂ absorption capacity, (iv) low energy requirement necessary for regeneration, (v) low vapor pressure and (vi) stability in the presence of oxygen.

The invention relates to an absorption medium which comprises an aqueous solution

(A) of at least one amino acid salt of the formula (I)

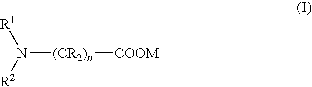

where R¹ and R² independently of one another are alkyl or hydroxyalkyl,
R is hydrogen, alkyl or hydroxyalkyl, or one radical R together with R¹ is alkylene,
M is an alkali metal and
n is an integer from 1 to 6, and

(B) at least one primary alkanolamine,

the absorption medium being essentially free from inorganic basic salts.

R¹ and R² are generally C₁-C₆-alkyl or C₂-C₆-hydroxyalkyl, preferably methyl or ethyl. R is hydrogen, alkyl (for example C₁-C₆-alkyl) or hydroxyalkyl (for example C₁-C₆-hydroxyalkyl). n is an integer from 1 to 6, preferably 1 or 2. One radical R can, together with R¹, be alkylene (for example C₂-C₄-alkylene).

The invention in addition relates to a process for removing carbon dioxide from a gas stream, which comprises bringing the gas stream into contact with the above defined absorption medium. In preferred embodiments, the partial pressure of the carbon dioxide in the gas stream is less than 500 mbar, for example 50 to 200 mbar. The gas stream can comprise oxygen (customarily 0.5 to 6% by volume) and traces of nitrogen oxides.

The remarks hereinafter with respect to the process of the invention apply mutatis mutandis to the absorption medium of the invention and vice versa, unless otherwise obvious from the context.

The amino acid salts used according to the invention have a tertiary amino group. They are distinguished from amino acid salts having a primary or secondary amino function by a lower heat of absorption. The heat of absorption of potassium dimethylamine-acetate is, for example, about 17% lower than that of potassium α-methylamino-propionate. The lower heat of absorption leads to a lower temperature increase in the absorber. In addition, the regeneration energy per kg of CO₂ removed is less.

Suitable amino acid salts are, for example, the alkali metal salts of α-amino acids, such as N,N-dimethylglycine (dimethylaminoacetic acid), N,N-diethylglycine (diethylaminoacetic acid), N,N-dimethylalanine (α-dimethylamino-propionic acid), N,N-dimethylleucine (2-dimethylamino4-methylpentan-1-oic acid), N, N-dimethylisoleucine (α-dimethylamino-β-methylvaleric acid), N, N-dimethylvaline (2-dimethylamino-3-methylbutanoic acid), N-methylproline (N-methylpyrrolidine-2-carboxylic acid), N,N-dimethylserine (2-dimethylamino-3-hydroxypropan-1-oic acid).

β-amino acids, such as 3-dimethylaminopropionic acid, N-methyliminodipropionic acid, N-methylpiperidine-3-carboxylic acid,

or aminocarboxylic acids such as N-methylpiperidine-4-carboxylic acid, 4-dimethylaminobutyric acid.

When the amino acid has one or more chiral carbon atoms, the configuration is of no importance; not only the pure enantiomers/diastereomers can be used, but also any desired mixtures or racemates.

The alkali metal salt is preferably a sodium salt or potassium salt, of which potassium salts are most preferred.

Particularly preferred amino acid salts (A) are
N,N-dimethylaminoacetic acid potassium salt,
N,N-diethylaminoacetic acid potassium salt, and
N-ethyl-N-methylaminoacetic acid potassium salt.

As component (B), the absorption medium of the invention comprises a primary alkanolamine. The primary alkanolamine acts as activator and accelerates the CO₂ uptake of the absorption medium by intermediate carbamate formation. In contrast to secondary amines, the primary alkanolamine does not form unwanted nitrosamines with nitrogen oxides, which can occur in the gas stream to be treated.

The alkanolamine (B) has at least one primary amino group and at least one hydroxyalkyl group. It typically comprises 2 to 12 carbon atoms, preferably 2 to 6 carbon atoms. One or more oxygen atoms in an ether bond can be present.

The alkanolamine (B) is preferably selected from
2-aminoethanol,
3-aminopropanol,
4-aminobutanol,
2-aminobutanol,
5-aminopentanol,
2-aminopentanol,
2-(2-aminoethoxy)ethanol.

Of these particular preference is given to 4-aminobutanol, 2-aminobutanol, 5-aminopentanol and 2-aminopentanol owing to their low vapor pressure.

Generally, the absorption medium comprises

15 to 50% by weight, preferably 20 to 40% by weight, in particular 30 to 40% by weight, amino acid salt (A) and

2 to 20% by weight, preferably 5 to 15% by weight, in particular 5 to 10% by weight, alkanolamine (B).

The absorption medium can also comprise additives, such as corrosion inhibitors, enzymes etc. Generally, the amount of such additives is in the range of about 0.01 to 3% by weight of the absorption medium.

The absorption medium of aqueous solution is essentially free from inorganic basic salts, that is it generally comprises less than about 10% by weight, preferably less than about 5% by weight, and in particular less than about 2% by weight, inorganic basic salts. Inorganic basic salts are, for example, alkali metal carbonates or alkaline earth metal carbonates or hydrogen carbonates, such as, in particular potassium carbonate (potash). Of course, the metal salt of the aminocarboxylic acid can be obtained by in-situ neutralization of an aminocarboxylic acid with an inorganic base such as potassium hydroxide; however, for this use is made of an amount of base not essentially going beyond the amount required for neutralization.

The gas stream is generally a gas stream which is formed in the following manner:
a) oxidation of organic substances for example combustion exhaust gases or flue gases,
b) composting and storage or waste materials comprising organic substances, or
c) bacterial decomposition of organic substances.

The oxidation can be carried out with appearance of flames, that is to say as conventional combustion, or as oxidation without appearance of flames, for example in the form of catalytic oxidation or partial oxidation. Organic substances which are subjected to combustion are customarily fossil fuels such as coal, natural gas, petroleum, gasoline, diesel, raffinates or kerosene, biodiesel or waste substances having a content of organic substances. Starting materials of the catalytic (partial) oxidation are, for example, methanol or methane, which can be converted to formic acid or formaldehyde.

Waste materials which are subjected to oxidation, composting or storage are typically domestic refuse, plastic wastes or packaging refuse.

Combustion of the organic substances usually proceeds in customary combustion plants with air. Composting and storage of waste materials comprising organic substances generally proceeds on refuse landfills. The exhaust gas or the exhaust air of such plants can advantageously be treated by the process according to the invention.

As organic substances for bacterial decomposition, use is customarily made of stable manure, straw, liquid manure, sewage sludge, fermentation residues and the like. Bacterial decomposition proceeds, for example, in conventional biogas plants. The exhaust air of such plants can advantageously be treated by the process according to the invention.

The process is also suitable for treating the exhaust gases of fuel cells or chemical synthesis plants which make use of a (partial) oxidation of organic substances. In addition, the process of the invention can of course also be employed to treat unburnt fossil gases, such as natural gas, for example what is termed coal-seam gases, that is gases arising in the extraction of coal, which are collected and compressed.

Generally, these gas streams under standard conditions comprise less than 50 mg/m³ of sulfur dioxide.

The starting gases can either have the pressure which approximately corresponds to the pressure of the ambient air, that is to say, for example atmospheric pressure, or a pressure which deviates from atmospheric pressure by up to 1 bar.

Devices suitable for carrying out the process of the invention comprise at least one scrubbing column, for example packed-bed columns, ordered-packing columns and tray columns, and/or other absorbers such as membrane contactors, radial stream scrubbers, jet scrubbers, Venturi scrubbers and rotary spray scrubbers. The gas stream is preferably treated with the absorption medium in this case in a scrubbing column in counter flow. The gas stream in this case is generally fed into the lower region of the column and the absorption medium into the upper region.

Suitable scrubbing columns for carrying out the process of the invention are also scrubbing columns made of plastic, such as polyolefins or polytetrafluoroethylene, or scrubbing columns, the inner surface of which is wholly or in part lined with plastic or rubber. In addition, membrane contactors having a plastic housing are also suitable.

The temperature of the absorption medium in the absorption step is generally about 25 to 70° C., when a column is used, for example 25 to 60° C., preferably 30 to 50° C., and particularly preferably 35 to 45° C., at the top of the column and, for example, 40 to 70° C. at the bottom of the column. A product gas low in carbon dioxide and other acid gas components, that is a product gas depleted in these components, is obtained, and an absorption medium loaded with acid gas components is obtained.

From the absorption medium loaded with the acid gas components, the carbon dioxide can be released in a regeneration step, a regenerated absorption medium being obtained. In the regeneration step, the loading of the absorption medium is decreased and the resultant regenerated absorption medium is preferably subsequently recycled to the absorption step.

Generally, the loaded absorption medium is regenerated by
a) heating, for example to 70 to 110° C.,
b) expansion,
c) stripping with an inert fluid
   or a combination of two or all of these measures.

Generally, the loaded absorption medium is heated for regeneration and the carbon dioxide released is separated off, for example in a desorption column. Before the regenerated absorption medium is reintroduced into the absorber, it is cooled to a suitable absorption temperature. To utilize the energy present in the hot regenerated absorption medium, it is preferred to preheat the loaded absorption medium from the absorber by heat exchange with the hot regenerated absorption medium. By means of the heat exchange, the loaded absorption medium is brought to a higher temperature, such that in the regeneration step a lower energy input is required. By means of the heat exchange, partial regeneration of the loaded absorption medium with release of carbon dioxide can already proceed. The resultant gas-liquid mixed phase stream is passed into a phase separation vessel, from which the carbon dioxide is taken off; the liquid phase is passed for complete regeneration of the absorption medium into the desorption column.

Frequently, the carbon dioxide released in the desorption column is subsequently compressed and fed, for example, to a pressure tank or sequestration. In these cases it can be advantageous to carry out the regeneration of the absorption medium at a higher pressure, for example 2 to 10 bar, preferably 2.5 to 5 bar. The loaded absorption medium is compressed to the regeneration pressure for this using a pump and introduced into the desorption column. The carbon dioxide is produced in this manner at a higher pressure level. The pressure difference from the pressure level of the pressure tank is relatively small and in some circumstances a compression stage can be saved. A higher pressure in the regeneration causes a higher regeneration temperature. At a higher regeneration temperature, a lower residual loading of the absorption medium can be achieved. The regeneration temperature is generally restricted only by the thermal stability of the absorption medium.

Before the absorption medium treatment of the invention, the combustion exhaust gas is preferably subjected to a scrubbing with an aqueous liquid, in particular water, in order to cool the flue gas and moisten it (quench). In the scrubbing, dusts or gaseous impurities such as sulfur dioxide can also be removed.

1. An absorption medium which comprises an aqueous solution
(A) of at least one amino acid salt of the formula (I) 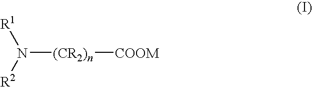
where R¹ and R² independently of one another are alkyl or hydroxyalkyl, R is hydrogen, alkyl or hydroxyalkyl, or one radical R together with R¹ is alkylene,
M is an alkali metal and
n is an integer from 1 to 6, and
(B) at least one primary alkanolamine,
the absorption medium being essentially free from inorganic basic salts.

2. The absorption medium according to claim 1, wherein the absorption medium comprises 15 to 50% by weight amino acid salt (A) and 2 to 20% by weight alkanolamine (B).

3. The absorption medium according to claim 2, wherein the absorption medium comprises 20 to 40% by weight amino acid salt (A) and 5 to 15% by weight alkanolamine (B).

4. The absorption medium according to one of the preceding claims, where M is potassium.

5. The absorption medium according to one of the preceding claims, wherein n is 1 or 2.

6. The absorption medium according to one of the preceding claims, wherein the amino acid salt (A) is selected from
N,N-dimethylaminoacetic acid potassium salt.
N,N-diethylaminoacetic acid potassium salt, and
N-ethyl-N-methylaminoacetic acid potassium salt.

7. The absorption medium according to one of the preceding claims, wherein the alkanolamine (B) is selected from
2-aminoethanol,
3-aminopropanol,
4-aminobutanol,
2-aminobutanol,
5-aminopentanol,
2-aminopentanol,
2-(2-aminoethoxy)ethanol.

8. A process for removing carbon dioxide from a gas stream, which comprises bringing the gas stream into contact with an absorption medium according to one of the preceding claims.

9. The process according to claim 8, wherein the partial pressure of the carbon dioxide in the gas stream is less than 500 mbar.

10. The process according to claim 8 or 9, wherein the gas stream comprises oxygen and if appropriate traces of nitrogen oxides.

11. The process according to claim 8 or 9, wherein the loaded absorption medium is regenerated by
a) heating,
b) expansion,
c) stripping with an inert fluid
or a combination of two or all of these measures.
